(19) United States
(12) Patent Application Publication
(10) Pub. No.: US 2014/0203767 A1
(43) Pub. Date: Jul. 24, 2014

(54) ELECTRIC INDUCTION CHARGER CAPABLE OF COLLECTING ELECTRIC WIRE

(71) Applicant: CERAMATE TECHNICAL CO., LTD., Taoyuan County (TW)

(72) Inventor: Robert Wang, Taoyuan County (TW)

(73) Assignee: CERAMATE TECHNICAL CO., LTD., Taoyuan County (TW)

(21) Appl. No.: 13/744,752

(22) Filed: Jan. 18, 2013

(51) Int. Cl. H02J 7/00; H04B 5/00

(52) U.S. Cl. CPC H02J 7/0052; H04B 5/0037; H04B 5/0093
USPC 320/108

(57) ABSTRACT

An electric induction charger capable of collecting an electric wire includes a charging body, a wire collection disk which is pivotally connected at one side of the charging body, and an electric wire. The charging body includes a power conversion unit therein. The power conversion unit is connected with a first coil. The wire collection disk includes a second coil therein. The second coil is electrically connected with the electric wire. Through the first coil and the second coil, the electric power is transmitted wirelessly from the charging body to the wire collection disk by using electromagnetic induction. The user can turn the wire collection disk to collect the electric wire. It is convenient for the user to store and carry the electric wire.

### BACKGROUND OF THE INVENTION

1. Field of the Invention

The present invention relates to an electric induction charger capable of collecting an electric wire.

2. Description of the Prior Art

As the quality of life and science and technology advance, various electronic products are developed, such as a note book, a smart phone, a Walkman, a mobile speaker, and the like, so that mobile devices play an important role these days. In general, the mobile device uses a built-in battery to provide electric power for operation. When the battery is low, the battery needs to be charged through a charger.

The charger comprises a charging body. The charging body is connected with an electric wire. The other end of the electric wire is connected with a connector to connect the mobile device. For the user to use the charger conveniently, the length of the electric wire is about 1 to 2 meters. This is inconvenient for the user to carry the charger. Accordingly, the inventor of the present invention has devoted himself based on his many years of practical experiences to solve these problems.

### SUMMARY OF THE INVENTION

The primary object of the present invention is to provide an electric induction charger capable of collecting an electric wire. The electric wire can be collected for the user to take along conveniently.

In order to achieve to the aforesaid object, the electric induction charger capable of collecting an electric wire of the present invention comprises a charging body, a wire collection disk and an electric wire. The charging body has a base. The base has a first pivot portion at one side thereof. The base is provided with a plug. The base comprises a power conversion unit therein. One end of the power conversion unit is electrically connected to the plug, and another end of the power conversion unit is electrically connected to a first coil.

The wire collection disk has a first side wall. One side of the first side wall has a connection portion protruding from a central portion thereof. Another end of the connection portion is provided with a second side wall opposite the first side wall. A wire collection trough surrounding the connection portion is defined between the first side wall and the second side wall. Another side of the first side wall has a second pivot portion. The second pivot portion is pivotally connected to the first pivotal portion so that the wire collection disk is rotatable relative to the charging body. The first side wall has a second coil therein. The electric wire surrounds the connection portion along with rotation of the wire collection disk to be collected in the wire collection trough. One end of the electric wire is provided with a first connector, and another end of the electric wire is electrically connected to the second coil.

According to the electric induction charger capable of collecting an electric wire of the present invention, the user can turn the wire collection disk and then the electric wire is wound around the connection portion along with rotation of the wire collection disk to be received in the wire collection trough. Thus, it is convenient for the user to store and carry the electric wire. Through the first coil and the second coil, the electric power is transmitted wirelessly from the charging body to the wire collection disk by using electromagnetic induction so there is no need for power transmission elements between the charging body and the wire collection disk.

### BRIEF DESCRIPTION OF THE DRAWINGS

FIG. 1 is a perspective view according to a preferred embodiment of the present invention;

FIG. 2 is a sectional view according to the preferred embodiment of the present invention;

FIG. 3 is a schematic view of the preferred embodiment of the present invention when in use;

FIG. 4 is a schematic view showing another use way of the preferred embodiment of the present invention; and

FIG. 5 is a schematic view showing operation of the preferred embodiment of the present invention.

### DETAILED DESCRIPTION OF THE PREFERRED EMBODIMENTS

Embodiments of the present invention will now be described, by way of example only, with reference to the accompanying drawings.

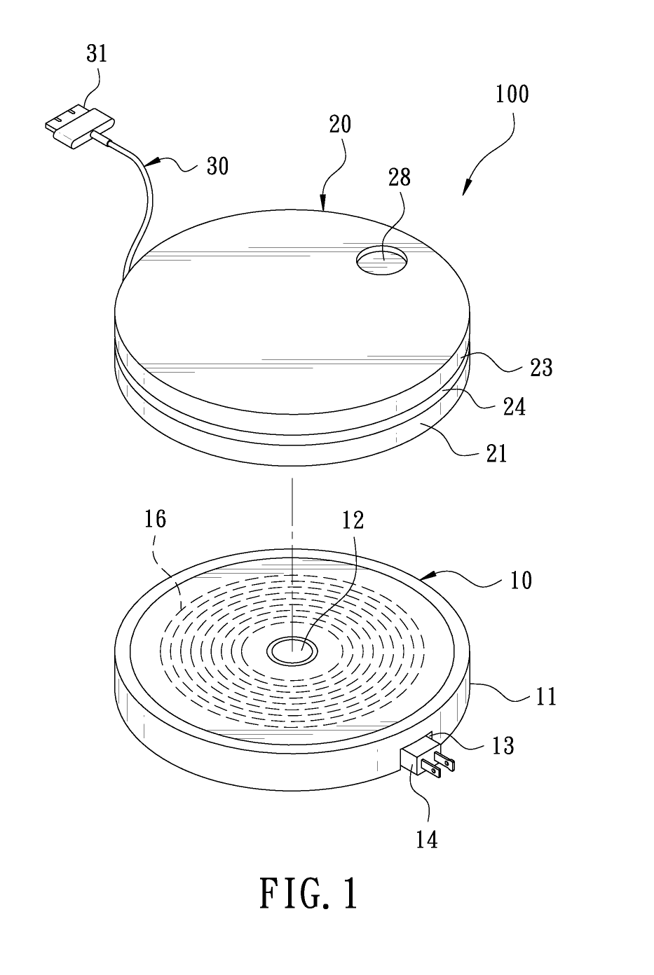

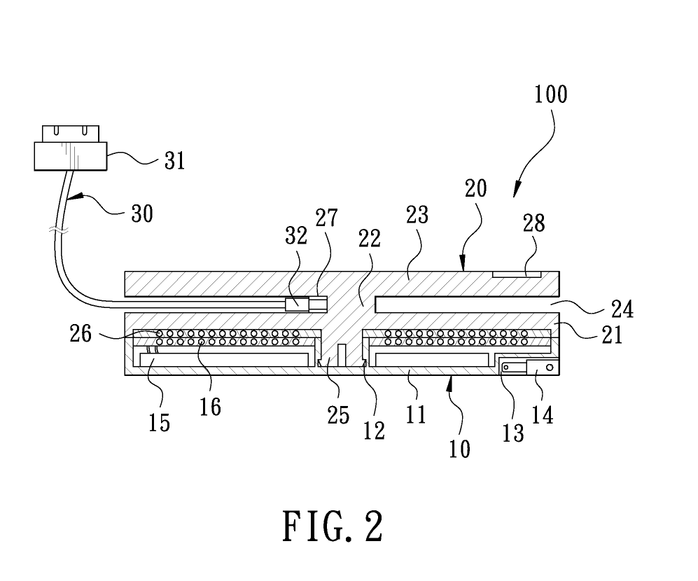

FIG. 1 is an exploded view according to a preferred embodiment of the present invention. FIG. 2 is a sectional view according to the preferred embodiment of the present invention. The present invention discloses an electric induction charger 100 capable of collecting an electric wire. The electric induction charger 100 comprises a charging body 10, a wire collection disk 20, and an electric wire 30.

The charging body 10 has a base 11. The base 11 has a first pivot portion 12 at one side thereof. In this embodiment, the first pivot portion 12 is a receiving trough. The base 11 further has a receiving notch 13 and a plug 14 which is pivotally connected in the receiving notch 13. The plug 14 can be overturned to be received in the receiving notch 13 or exposed out of the base 11. The base 11 further comprises a power conversion unit 15 therein. One end of the power conversion unit 15 is electrically connected to the plug 14, and another end of the power conversion unit 15 is electrically connected to a first coil 16.

The wire collection disk 20 has a first side wall 21. One side of the first side wall 21 has a connection portion 22 protruding from a central portion thereof. Another end of the connection portion 22 is provided with a second side wall 23 opposite the first side wall 21. A wire collection trough 24 surrounding the connection portion 22 is defined between the first side wall 21 and the second side wall 23. In this embodiment, the connection portion 22 is a cylinder. Another side of the first side wall 21 has a second pivot portion 25. The second pivot portion 25 is pivotally connected to the first pivotal portion 12, so that the wire collection disk 20 is rotatable relative to the charging body 10. In this embodiment, the second pivot portion 25 is an insertion post. The first side wall 21 has a second coil 26 therein. The connection portion 22 has a connection port 27 at a peripheral side thereof. The connection port 27 is electrically connected to the second coil 26. The second side wall 23 has a recess 28 close to an outer side edge thereof.

The electric wire 30 surrounds the connection portion 22 along with rotation of the wire collection disk 20 to be collected in the wire collection trough 24. One end of the electric wire 30 is provided with a first connector 31, and the other end of the electric wire 30 is electrically connected to the second coil 26. In this embodiment, the other end of the electric wire 30 is provided with a second connector 32. The second connector 32 is plugged to the connection port 27. Through the connection port 27, the electric wire 30 is electrically connected with the second coil 26

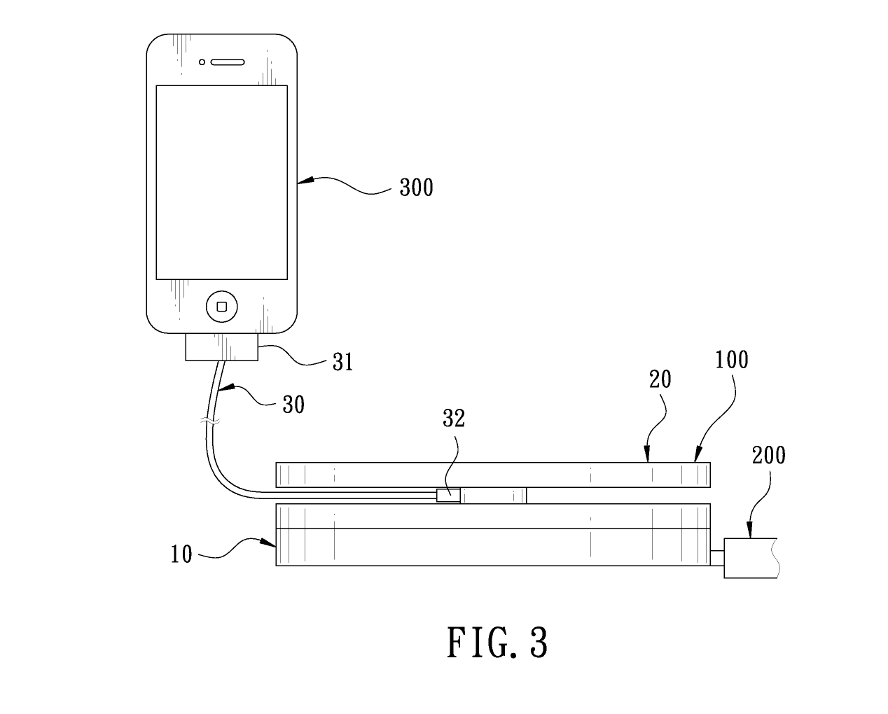

FIG. 3 is a schematic view of the preferred embodiment of the present invention when in use. When the electric induction charger 100 is used, the plug 14 is overturned from the receiving notch 13 by the user for the plug 14 to be exposed out of the base 11, and then the plug 14 is connected to an external socket 200. The wire collection disk 20 is turned to release the electric wire 30 and the first connector 31 is connected to a mobile device 300, such that the electric induction charger 100 is connected between the external socket 200 and the mobile device 300. The external socket 200 provides electric power, and the power conversion unit 15 coverts the electric power into the required power specification of the mobile device 300 to the first coil 16. By using the first coil 16, the electric power is converted into magnetism. Meanwhile, the second coil 26 of the wire collection disk 20 starts to generate electric power by magnetic excitation based on the principle of Faraday electromagnetic induction, and the electric power is transmitted to the electric wire 30 through the connection port 27. The electric wire 30 transmits the electric power to the mobile device 300 for the mobile device 300 to be charged.

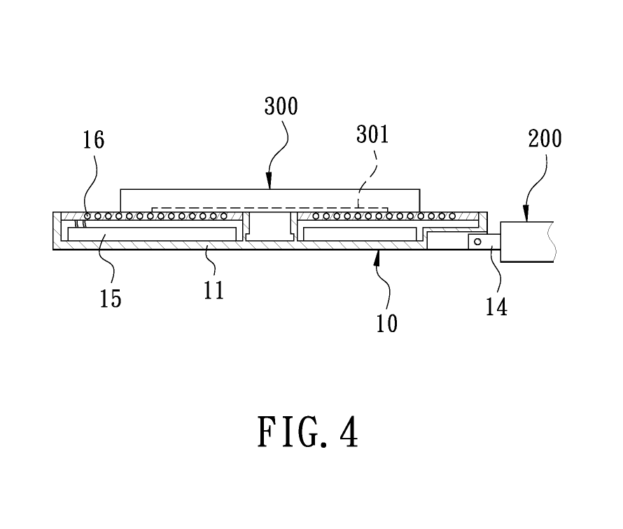

FIG. 4 is a schematic view showing another use way of the preferred embodiment of the present invention. The mobile device 300 has an induction coil 301. When in use, the wire collection disk 20 is detached from the charging body 10, and the plug 14 is connected to the external socket 200. After that, the mobile device 300 is placed on the charging body 10. Through the first coil 16, the induction coil 301 starts to generate electric power by magnetic excitation for the mobile device 300 to be charged.

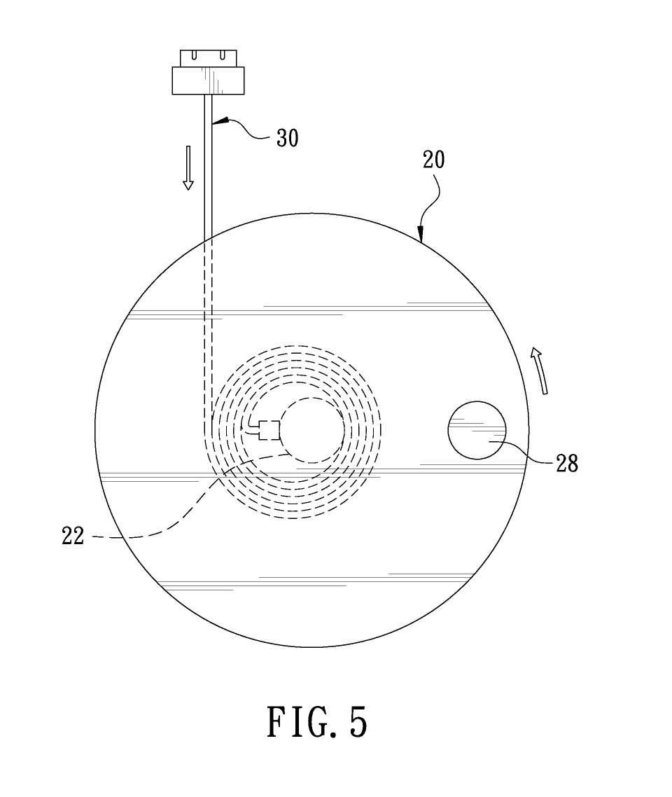

FIG. 5 is a schematic view showing operation of the preferred embodiment of the present invention. After the mobile device 300 is charged, the plug 14 is unplugged from the external socket 200 and overturned to be received in the receiving trough 13. Afterward, the first connector 31 is detached from the mobile device 300, and the wire collection disk 20 is turned through the recess 28. The electric wire 30 is wound around the connection portion 22 along with rotation of the wire collection disk 20 to be received in the wire collection trough 24. Thus, it is convenient for the user to store and carry the electric wire 30.

It is noted that through the first coil 16 and the second coil 26 the electric power is transmitted wirelessly from the charging body 10 to the wire collection disk 20 by using electromagnetic induction so there is no need for power transmission elements (such as metallic pins) between the charging body 10 and the wire collection disk 20.

It is noted that the electric wire 30 is connected to the connection port 27 through the second connector 32 to be electrically connected with the second coil 26. Therefore, the use can detach the electric wire 30 from the wire collection disk 20 easily so as to replace the electric wire 30 having a different first connector 31.

Furthermore, the present invention comprises a spiral spring (not shown in the drawings) between the first pivot portion 12 and the second pivot portion 25 to provide an automatic wire collection effect.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An electric induction charger, comprising:
a charging body having a base, the base having a first pivot portion at one side thereof, the base being provided with a plug, the base comprising a power conversion unit therein, one end of the power conversion unit being electrically connected to the plug, another end of the power conversion unit being electrically connected to a first coil;
a wire collection disk having a first side wall, one side of the first side wall having a connection portion protruding from a central portion thereof, another end of the connection portion being provided with a second side wall opposite the first side wall, a wire collection trough surrounding the connection portion being defined between the first side wall and the second side wall, another side of the first side wall having a second pivot portion, the second pivot portion being pivotally connected to the first pivotal portion so that the wire collection disk is rotatable relative to the charging body, the first side wall having a second coil therein; and
an electric wire surrounding the connection portion along with rotation of the wire collection disk to be collected in the wire collection trough, one end of the electric wire being provided with a first connector, another end of the electric wire being electrically connected to the second coil.

2. The electric induction charger as claimed in claim 1, wherein the first pivot portion is a receiving trough and the second pivot portion is an insertion post.

3. The electric induction charger as claimed in claim 1, wherein the connection portion is a cylinder.

4. The electric induction charger as claimed in claim 1, wherein the connection portion has a connection port at a peripheral side thereof, the connection port is electrically connected to the second coil, the other end of the electric wire is provided with a second connector, the second connector is plugged to the connection port, and the electric wire is electrically connected with the second coil through the connection port.

5. The electric induction charger as claimed in claim 1, wherein the base further has a receiving notch and the plug is pivotally connected in the receiving notch.

6. The electric induction charger as claimed in claim 1, wherein the second side wall has a recess close to an outer side edge thereof.
